(19) United States
(12) Patent Application Publication
(10) Pub. No.: US 2025/0000301 A1
(43) Pub. Date: Jan. 2, 2025

(54) BURR-ADJUSTMENT SYSTEM FOR A COFFEE GRINDER

(71) Applicant: Breville Pty Limited, Alexandria NSW (AU)

(72) Inventors: David Joel LITTRELL, Alexandria NSW (AU); Kyle Taylor ANDERSON, Alexandria NSW (AU)

(21) Appl. No.: 18/694,662

(22) PCT Filed: Sep. 26, 2022
(86) PCT No.: PCT/AU2022/051149

§ 371 Date: Mar. 22, 2024

(30) Foreign Application Priority Data
Sep. 24, 2021 (AU) 2021903074

(51) Int. Cl. A47J 42/08

(52) U.S. Cl. CPC A47J 42/08

(57) ABSTRACT

A burr-adjustment system for a coffee grinder includes a burr portion for a first grinding burr; and a guide for coupling to the coffee grinder. The guide is engageable with the burr portion via an engagement feature such that, when engaged, the guide is rotatable about a rotation axis with respect to the burr portion to longitudinally adjust the burr portion relative to the guide.

The engagement feature includes track portions and follower portions. The track portions are angularly and/or longitudinally offset with respect to each other about the rotation axis. Each track portion spirals in a longitudinal direction about the rotation axis and has a pitch profile with a first pitch in a first region and a second pitch, that is less than the first pitch, in a second region. The pitch profiles of the track portions are substantially similar.

### RELATED APPLICATIONS

The present application claims convention priority from Australian Provisional Patent Application No. 2021903074, the contents of which are incorporated herein in their entirety by reference thereto.

### FIELD

The present invention relates to a burr-adjustment for a coffee grinder. In particular, preferred embodiments relate to adjusting a height of the grinder burrs relative to each other to adjust a grind size from coffee beans contained in a grinding space between the grinding burrs.

### BACKGROUND

Existing coffee grinders do not allow for a wide range of adjustable grind (particle) sizes and the ability to fine-tune the grind size especially when preparing an espresso. Micro-adjustability for grind sizes is essential in the espresso range of grind, but not needed (nor practical) in the coarser grind ranges.

### SUMMARY OF INVENTION

An object of preferred embodiments of the present invention seeks to address the problems outlined above and/or to at least provide the public with a useful choice.

An aspect of the present invention provides a burr-adjustment system for a coffee grinder, the burr-adjustment system including: a burr portion for a first grinding burr; and a guide for receiving the burr portion, the burr portion being engageable with the guide via an engagement feature such that, when engaged, the guide is rotatable about a rotation axis with respect to the burr portion to longitudinally adjust the burr portion relative to the guide, wherein the engagement feature includes: track portions that are angularly and/or longitudinally offset with respect to each other about the rotation axis, each track portion spirals in a longitudinal direction about the rotation axis and has a pitch profile with a first pitch in a first region and a second pitch, that is less than the first pitch, in a second region, the pitch profiles of the track portions being substantially similar, and follower portions that are angularly and/or longitudinally offset with respect to each other about the rotation axis, each follower portion being engageable with a respective track portion, wherein the rotation of the guide with respect to the burr portion about the rotation axis causes each follower portion to be guided along the respective track portion to which it is engaged to thereby longitudinally adjust the burr portion with respect to the guide, wherein the follower portions transition between the first and second regions of the respective track portions in unison upon rotation of the guide with respect to the burr portion.

The track portions are provided in one of the burr portion or the guide, while the follower portions are provided in the other of the burr portion or the guide. In a preferred example, the track portions are provided in the guide and the follower portions are provided in the burr portion. In another example, the track portions and provided in the burr portion and the follower portions are provided in the guide.

The coffee grinder, for which the burr-adjustment system is provided, preferably includes a first grinding burr and a second grinding burr that is centrally located with respect to the first grinding burr, the second grinding burr being rotatable relative to the first grinding burr to grind coffee beans contained in a space between the first grinding burr and the second grinding burr. The burr portion of the burr-adjustment system may be of the first grinding burr. Preferably, rotation of the burr portion relative to the guide of the burr-adjustment system adjusts the height of the first grinding burr with respect to the second grinding burr to adjust a grind size from grinding coffee beans in the space between the first grinding burr and the second grinding burr.

Preferably, the track portions are angularly offset with respect to each other about the rotation axis by a first angle that is about 360° divided by a number of track portions. Similarly, the follower portions are preferably angularly offset with respect to each other about the rotation axis also by the first angle. By way of example, the track portions include two track portions that are separated from each other by about 180°, and the follower portions include two follower portions that are separated from each other also by about 180°. By way of example, the track portions include three track portions that are separated from each other by about 120°, and the follower portions include three follower portions that are separated from each other also by about 120°. By way of example, the track portions include four track portions that are separated from each other by about 90°, and the follower portions include four follower portions that are separated from each other also by about 90°. By way of example, the track portions include n track portions that are separated from each other by about 360°/n, and the follower portions include n follower portions that are separated from each other also by about 360°/n, n being an integer greater than zero.

A starting end of each track portion may be angularly offset with respect to a starting end of another track portion by the first angle. A finishing end of each track portion may be angularly offset with respect to a finishing end of another track portion by the first angle. Each track portion preferably has a length from the starting end to the finishing end, which defines a travel distance for the respective follower portion. The lengths of the track portions may be substantially equal to each other.

The track portions are preferably longitudinally offset with respect to each other. Similarly, the follower portions are also preferably longitudinally offset with respect to each other. Where the track portions comprise more than two track portions, there is preferably a constant longitudinal spacing between sequential track portions. Similarly, where the follower portions comprise more than two follower portions, there is a constant longitudinal spacing between sequential follower portions.

In a preferred embodiment, the track portions include three track portions and the follower portions include at three follower portions each follower portion being engageable with a respective track portion. Preferably, the three track portions include a first track portion, a second track portion, and a third track portion, the second track portion being angularly offset from the first track portion by about 120° and the third track portion being angularly offset from the second track portion also by about 120°. The three track portions are preferably longitudinally offset from each other. Preferably, the three follower portions include a first follower portion, a second follower portion, and a third follower portion, the second follower portion being angularly offset from the first follower portion by about 120° and the third follower portion being angularly offset from the second follower portion also by about 120°. The three follower portions are preferably longitudinally offset from each other.

In one example, the guide includes the track portions and the burr portion includes the follower portions. In another example, the guide includes the follower portions and the burr portions include the track portions.

Preferably, for each track portion, the second region is at a lower elevation than the first region. Alternatively, for each track portion, the second region is at a higher elevation than the second region.

Each track portion preferably spirals in the longitudinal direction by a dwell angle. The dwell angle is an angle about the rotation axis from one end of the track portion to an opposite end of the track portion. The first region may be in a first half of the dwell angle and the second region being in a second half of the dwell angle. Preferably, the first half is an upper half of the respective track portion and the second half is a lower half of the respective track portion. Alternatively the second half is an upper half of the respective track portion and the first half is a lower half of the respective track portion. The dwell angle is preferably at least about a first angle that is about 360° divided by a number of track portions. For example, the first angle is about 180° for two track portions, about 120° for three track portions, about 90° for four track portions, and 360°/n for n track portions, n being an integer greater than zero. The dwell angle may be at least 10%, at least 20%, at least 30%, at least 40% or at least 50%, or at least about 100% of the first angle. The dwell angle may be between about 40% and 50% of the first angle. Preferably, where the track portions include three track portions, the dwell angle is about 170°.

The first pitch may be at least about 2 times larger than the second pitch. For example, the first pitch may be at least about 5 times larger, about 10 times larger, or about 20 times larger than the second pitch.

The first pitch may be at least about 5 μm/°, at least about 10 μm/°, at least about 15 μm/°, or at least about 20 μm/° for example. Preferably, the first pitch is between about 20 μm/° and 40 μm/°. Further preferably, the first pitch is between about 25 μm/° and 35 μm/°. Even further preferably, the first pitch is about 27 μm/°.

The second pitch may be up to about 5 μm/°, up to about 10 μm/°, up to about 15 μm/°, or up to about 20 μm/° for example. Preferably, the second pitch is between about 1 μm/° and 5 μm/°. Further preferably, the second pitch is between about 2 μm/° and 3 μm/°. Even further preferably, the second pitch is about 2.4 μm/°.

In another example, each track portion may have one or more intermediate pitches in respective one or more intermediate regions, the or each intermediate region being between the first and second region. Preferably, the or each intermediate pitch is less than the first pitch and larger than the second pitch.

Preferably, each follower portion is complementarily mateable with the respective track portion. In a preferred example, each track portion is a groove and each follower portion is a protrusion that is locatable in the groove of the respective track portion. In this example, each track portion is an elongate portion having an inwardly-convex surface and the follower portion has an outwardly convex surface to complementarily mate with the track portion. In another example, each track portion is an elongate portion having a bulging or an outwardly-concave surface and the follower portion has a cup-shape or an inwardly convex surface to complementarily mate with the track portion.

Each follower portion may have a width that is different from a width of the other follower portion(s) and the engagement feature has a plurality of entry regions, each entry region being for the respective follower portion and leading to the track portion, the entry region having a width that corresponds to the width of the respective follower portion. The entry region may be a recessed portion leading to the respective track portion. In this example, the burr portion is removably locatable with respect to the guide by aligning the follower portions with the entry regions of the respective track portions.

In one example, the burr portion is a burr holder for removably receiving a first grinding burr, the first grinding burr when received by the burr holder being height-adjustable, in unison with the burr holder, relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr. The first grinding burr may be a ring burr and the second grinding burr may be a conical burr that is centrally located with respect to the ring burr.

In another example, the burr portion is an integral part of a first grinding burr, the first grinding burr being height-adjustable relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr. The first grinding burr may be a ring burr and the second grinding burr may be a conical burr that is centrally located with respect to the ring burr.

A further aspect of the present invention provides a burr-adjustment system for a coffee grinder, the burr-adjustment system including: a burr portion for a first grinding burr; and a guide for coupling to the coffee grinder, the guide being engageable with the burr portion via an engagement feature such that, when engaged, the guide is rotatable about a rotation axis with respect to the burr portion to longitudinally adjust the burr portion relative to the guide, wherein the engagement feature includes: a track portion that spirals in a longitudinal direction about the rotation axis and has a pitch profile with a first pitch in a first region and a second pitch, that is less than the first pitch, in a second region, and a follower portion that is engageable with a respective track portion.

The burr-adjustment system according to this aspect may include one or more features of the burr-adjustment system of the aspect previously described above.

Another aspect of the present invention provides a coffee grinder including: a first grinding burr; a second grinding burr that is centrally located with respect to the first grinding burr, the second grinding burr being rotatable relative to the first grinding burr to grind coffee beans contained in a space between the first grinding burr and the second grinding burr; and the burr-adjustment system of either of the aspects previously described, wherein the burr portion of the burr-adjustment system is of the first grinding burr; and wherein rotation of the guide relative to the burr portion of the burr-adjustment system adjusts the height of the first grinding burr with respect to the second grinding burr to adjust a grind size from grinding of coffee beans in the space between the first grinding burr and the second grinding burr.

The first grinding burr may be a ring burr and the second grinding burr may be a conical burr that is centrally located with respect to the ring burr.

The burr portion may be burr holder for holding the first grinding burr or may be integral with the first grinding burr.

In one example, the burr portion is a burr holder for removably receiving the first grinding burr, the first grinding burr when received by the burr holder being height-adjustable, in unison with the burr holder, relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr.

In another example, the burr portion is an integral part of the first grinding burr, the first grinding burr being height-adjustable relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr. The first grinding burr may be a ring burr and the second grinding burr may be a conical burr that is centrally located with respect to the ring burr.

Another aspect of the present invention provides a coffee grinder comprising: a first grinding burr; a second grinding burr; and an adjustment mechanism that is rotatable to adjust a height of the first grinding burr with respect to the second grinding burr to adjust a grind size from grinding of coffee beans in a space between the first grinding burr and the second grinding burr, the adjustment mechanism comprising a plurality of circumferentially spaced apart track portions, each track portion being engageable with a respective follower portion and having a varying pitch along its length, wherein a rotation of the adjustment mechanisms results in a translational movement of the track portions relative to the respective follower portions to thereby adjust the height of the first grinding burr with respect to the second grinding burr; wherein the first grinding burr has or is engageable with the adjustment mechanism.

Preferably, the first grinding burr is engageable with the adjustment mechanism; and the first grinding burr includes the follower portions that are engageable with the respective track portions. Alternatively, the first grinding burr may have the adjustment mechanism and the follower portions may be provided on walls of an aperture in which the first grinding burr is rotatably locatable.

The track portions are preferably non-contiguous.

Yet a further aspect of the present invention provides a coffee grinder comprising: a first grinding burr; a second grinding burr; a burr holder having a plurality of follower portions, wherein the first grinding burr has or is engageable with the burr holder; and an adjusting ring comprising a plurality of circumferentially spaced apart track portions, each track portion having a varying pitch, wherein the adjusting ring is rotatable relative to the burr holder to adjust a height of the first grinding burr with respect to the second grinding burr to adjust a grind size from grinding of coffee beans in a space between the first grinding burr and the second grinding burr, and wherein the varying pitch of each track portion provides a non-uniform height adjustment of the first grinding burr with respect to the second grinding burr upon rotation of the adjusting relative to the burr holder.

Another aspect of the present invention provides a beverage ingredient grinder comprising: a first grinding element; a second grinding element spaced apart from the first grinding element to define a grinding chamber for a beverage ingredient; and an adjustment mechanism comprising: an adjusting ring comprising a plurality of circumferentially spaced apart track portions, each track portion comprises or includes a varying pitch, wherein a rotation of the adjustment ring adjusts the distance between the first and second grinding elements

A further aspect of the present invention provides a beverage ingredient grinder comprising: a first grinding element; a second grinding element, the second grinding element spaced apart from the first grinding element to define a grinding chamber for the beverage ingredient; and an adjustment mechanism comprising: an adjusting ring comprising a plurality of non-contiguous track portions, wherein each track portion comprises or includes a varying pitch, wherein a rotation of the adjustment ring adjusts the distance between the first and second grinding elements.

Yet a further aspect of the present invention provides a beverage ingredient grinder comprising: a first grinding element; a second grinding element spaced apart from the first grinding element to define a grinding chamber for a beverage ingredient; and an adjustment mechanism comprising: an adjusting ring comprising at least one track portion, wherein the at least one track portion comprises or includes a varying pitch; and wherein a rotation of the adjustment ring adjusts the distance between the first and second grinding elements.

### BRIEF DESCRIPTION OF DRAWINGS

Preferred embodiments will now be described, by way of non-limiting example, with reference to the accompanying drawings, in which:

FIGS. 1A to 1C show perspective, sectional-side, and exploded perspective views respectively of a coffee grinder according to an embodiment of the present invention;

FIGS. 2A and 2B show perspective and exploded perspective views respectively of a burr-adjustment system according to an embodiment of the present invention;

FIGS. 3A to 3D show perspective, top, sectional-perspective, and split-open views respectively of a guide of the burr-adjustment system according to an embodiment of the present invention; and

FIGS. 4A to 4C show perspective, top, and side views respectively of a guide of the burr-adjustment system according to an embodiment of the present invention

### DESCRIPTION OF EMBODIMENTS

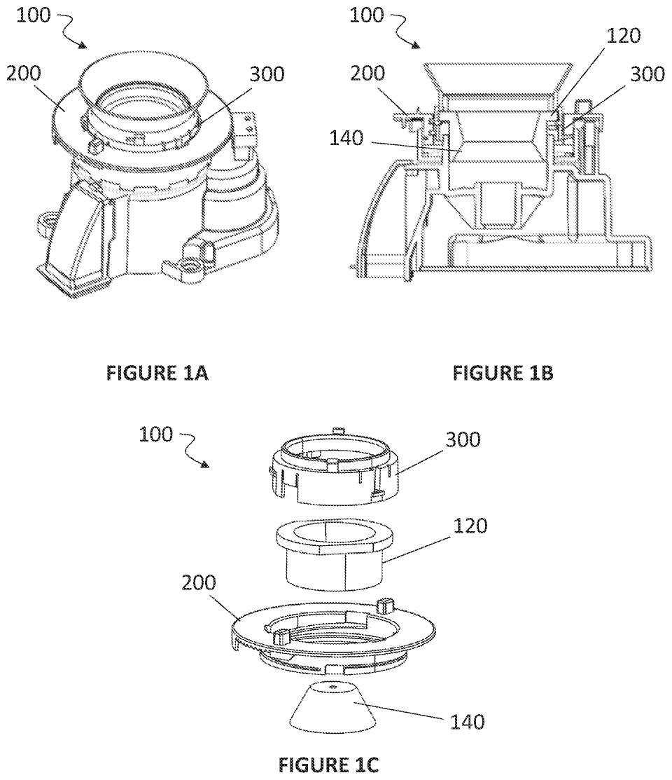

Referring to FIGS. 1A to 1C, a coffee grinder 100 according to an embodiment of the present invention includes a first grinding burr 120, a second grinding burr 140, and a burr-adjustment system, having an adjustment ring 200 and a burr holder 300 that is rotatably engageable with the adjustment ring 200, for adjusting a height or elevation of one of the grinding burrs with respect to the other grinding burr along a longitudinal (or vertical) axis. The longitudinal axis is parallel to a rotation axis about which the grinding burr(s) 120, 140 is/are configured to rotate. The first and second grinding burrs 120, 140 face each other along an axial direction and define a grinding chamber for coffee beans. The coffee grinder 100 is an example of a beverage ingredient grinder, i.e.—a grinder for grinding the beverage ingredient, which in one example includes coffee beans.

The first grinding burr 120 is a first grinding element. The first grinding burr 120 is a ring burr having an inner circumferential wall and an outer circumferential wall. In another example, the first grinding burr may be a flat burr. The first grinding burr 120 has a grinding surface on the inner circumferential wall of the ring burr. As will be discussed in further detail below, the outer circumferential wall is co-operable with the burr-adjustment system for height-adjustment of the first grinding burr 120 with respect to the second grinding burr 140. The inner circumferential wall of the first grinding burr is tapered to define a frustoconincal-shaped space.

The second grinding burr 140 is a second grinding element. The second grinding burr 140 is a conical burr having a grinding surface on an outer circumferential wall. In particular, when assembled, the outer circumferential wall of the second grinding burr 140 is tapered in an upward direction while the inner circumferential wall of the first grinding burr is tapered in a downward direction. In particular, the second grinding burr 140 has a diameter or width that varies along a height thereof. The grinding surface of the second grinding burr 140 faces the grinding surface of the first grinding burr 120. The second grinding burr 140 is centrally or coaxially located with respect to the first grinding burr 120 such that the inner circumferential wall of the first grinding burr 120 faces the outer circumferential wall of the second grinding burr 140. A grinding space or chamber is defined between the grinding surfaces of the respective first and second grinding burrs 120, 140 for containing coffee beans to be ground. The second grinding burr 140 is rotatable relative to the first grinding burr 120 about a rotation axis to grind coffee beans contained in the grinding space/chamber. In a preferred embodiment, the first grinding burr 120 is stationary, while the second grinding burr 140 is rotatable. In another embodiment, the first grinding burr 120 is rotatable, while the second grinding burr 140 is stationary. In yet another embodiment, the first grinding burr 120 is rotatable in a first direction and the second griding burr 140 is rotatable in a second, opposite, direction. In the example shown in FIGS. 1A to 1C, the outer circumferential wall of the first grinding burr 120 is co-operable with the burr-adjustment system for height-adjustment of the first grinding burr 120 with respect to the second grinding burr 140. In another example, the second grinding burr is co-operable with the burr-adjustment system for height adjustment of the grinding burrs with respect to each other.

The burr-adjustment system is configurable to adjust the height or elevation of one grinding burr with respect to the other grinding burr to adjust a grind size from the coffee beans contained in the grinding space between the first and second grinding burrs. In particular, the grinding space has a circumferential width corresponding to a distance or separation between the inner circumferential wall (or girding surface) of the first grinding burr 120 and the outer circumferential wall (or grinding surface) of the second grinding burr 140. Because the first grinding burr 120 has a tapered inner circumferential wall and the second grinding burr 140 has a tapered outer circumferential wall is conical having a diameter that varies along its height, the circumferential width of the grinding space (being a distance between the inner circumferential wall of the first grinding burr and the outset circumferential wall of the second grinding burr) can be varied by changing the height or elevation of the first grinding burr 120 with respect to the second grinding burr 140. The elevation of the first grinding burr 120 with respect to the second grinding burr 140 can be adjusted to either enlarge the grinding space (by drawing the grinding surfaces of the first and second grinding burrs 120, 140 away from each other to provide a larger grind size) or to enclose the grinding space (by drawing the grinding surfaces of the first and second grinding burrs 120, 140 toward each other to provide a smaller grind size). Movement of the first grinding burr 120 with respect to the second grinding burr 140 in a first longitudinal direction would enclose the grinding space to provide finer grind sizes, while movement of the first grinding burr 120 with respect to the second grinding burr 140 in a second, opposite, longitudinal direction would enlarge the grinding space to provide larger/coarser grind sizes.

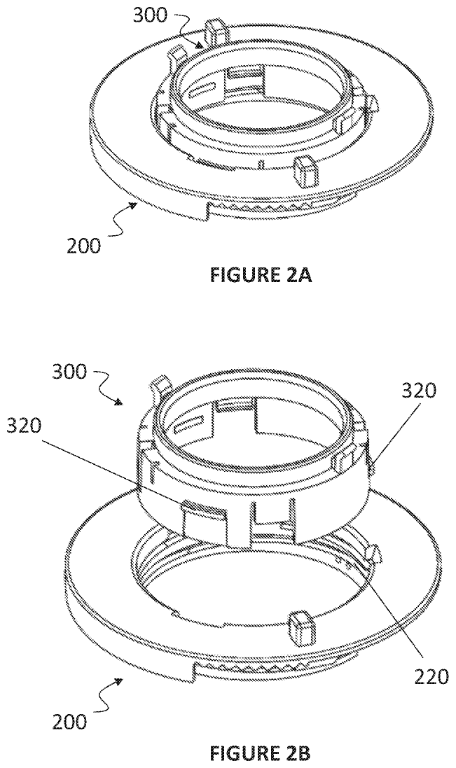

With reference to FIGS. 2A and 2B, the burr-adjustment system for the coffee grinder includes a guide 200 and a burr portion 300. The burr portion 300 is for holding the first grinding burr (120 in FIGS. 1A to 1C) such that the first grinding burr moves in unison with the burr portion 300. In particular, the burr portion 300 cooperates with the outer circumferential wall of the first grinding burr to hold the first grinding burr such that the first grinding burr moves in unison with the burr portion. In another example, the burr portion may be integral with the first grinding burr. In this other example the features of the burr portion are provided on the circumferential wall of the first grinding burr. The burr portion 300 engages the guide 200 via an engagement feature, such that rotation of the guide 200 about the rotation axis causes a longitudinal movement of the burr portion 300 relative to the guide 200. In particular, rotation of the guide 200 in a first direction about the rotational axis causes the burr portion to move upwardly relative to the guide 200, while rotation of the guide in a second, opposite, direction about the rotational axis causes the burr portion to move downwardly relative to the guide 200. The rotation of the guide 200 causes a translational longitudinal movement of the burr portion 300 relative to the guide 200. Thereby, the first griding burr to which the burr portion 300 is mounted (or the first grinding burr having the burr portion as an integral feature) also moves longitudinally in unison with the burr portion 300 with respect to the second grinding burr to adjust the grinding space to thereby adjust the grind size from coffee beans contained in the grinding space.

As previously described, the burr portion 300 engages the guide 200 via an engagement feature. The engagement feature includes a track-and-follower, or a lock-and-key, arrangement. In particular, the engagement feature includes track portions 220 and follower portions 320 that are engageable with the track portions 220. Each follower portion 320 is complementarily mateable with a respective track portion 220. In a preferred example, each track portion 220 is a groove and each follower portion 320 is an outwardly-projecting protrusion that is locatable in the groove of the respective track portion 220. In this example, each track portion 220 is an elongate portion having an inwardly-convex (or recessed) surface and the follower portion 320 has an outwardly convex (or protruding) surface to complementarily mate with the track portion. In another example, each track portion is an elongate portion having a protruding, bulging or an outwardly-concave surface and the follower portion has a recessed, cup-shape or an inwardly convex surface to complementarily mate with the track portion.

The track portions 220 are angularly and longitudinally offset with respect to each other about the rotation axis. The track portions are non-contiguous and non-continuous with respect to each other. Each track portion 220 spirals in a longitudinal direction about the rotation axis and has a varying pitch profile. In particular, each track portion has a first pitch in a first region and a second pitch, that is less than the first pitch, in a second region. The pitch profiles of the track portions are substantially similar (or identical) such that the respective follower portions, which are mateable with the track portions, would move together, or in concert with each other, along the respective track portions upon rotation of the guide 200 relative to the burr portion 300. The follower portions 320 are also angularly and longitudinally offset with respect to each other about the rotation axis.

In the example shown in the drawings, the track portions 220 are provided on the guide 200 and the follower portions 320 are provided on the burr portion 300. In other examples, the track portions may be provided on the burr portion and the follower portions may be provided on the guide. Rotation of the guide 200 with respect to the burr portion 300 about the rotation axis causes each follower portion 320 to be guided along the respective track portion 220 to which it is engaged to thereby longitudinally adjust the burr portion 300 with respect to the guide 200. As the track portions have a substantially similar pitch profile, the follower portions 320 transition along and between the first and second regions of the respective track portions 220 in unison upon rotation of the guide 200 with respect to the burr portion 300.

In another example, the guide may be a shaft and the central grinding burr has a longitudinally-extending channel therethrough through which the shaft is passable. In this example, the central grinding burr has a burr portion (that is either integrally formed with the channel or a separate component that is locatable within the channel) that is engageable with the shaft via the described engagement feature. The engagement feature would allow for a longitudinal movement of the central grinding burr with respect to the ring grinding burr, along the length of the shaft, upon rotation of the shaft about a rotation axis to thereby adjust the grinding space between the grinding burrs.

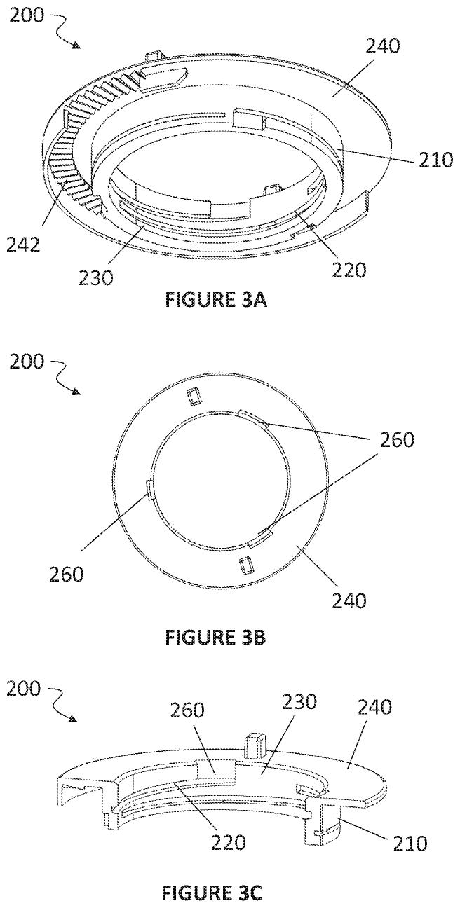

With reference to FIGS. 3A to 3C, the guide 200 is ring-shaped (or annular) collar in which the burr portion (300 in FIGS. 2A and 2B) is locatable. The collar has an outer circumferential wall 210 and an inner circumferential wall 230. The guide 200 has a flange 240 extending from the outer circumferential wall 230. The flange has a geared surface 242 on its underside that is engageable with a detent of the coffee grinder to prevent an unwanted rotation of the guide 200 and/or to provide tactile feedback as the guide 200 is rotated. The detent is spring-loaded. The guide 200 is rotatably mounted to the housing of the coffee grinder and receives the burr portion such that the guide 200 is rotatable relative to the housing to adjust the height of the burr portion. The burr portion can be completely removed from the guide 200.

The track portions (or threads) 220 are provided on the inner circumferential wall 210 of the guide. The track portions 220 are non-contiguous and non-continuous with each other. That is, each track portion 220 has a respective starting end and a respective finishing end that are physically separate from the start and end portions of the other track portions 220. Each track portion 220 spirals along the inside of the guide 220 in a longitudinal direction about the rotation axis. There are three track portions 220 that are angularly and longitudinally spaced apart from each outer about the rotation axis. The three track portions 220 include a first track portion, a second track portion, and a third track portion. The second track portion is angularly offset from the first track portion by about 120°, and the third track portion is angularly offset from the second track portion also by about 120°. In other examples, the track portions are angularly offset but longitudinally aligned with respect to each other about the rotation axis. In yet other examples, the track portions are angularly aligned but longitudinally offset with respect to each other about the rotation axis.

A starting end of each track portion 220 is angularly offset with respect to a starting end of another track portion 220 by a first angle. A finishing end of each track portion 220 is also angularly offset with respect to a finishing end of another track portion 220 also by the first angle. Each track portion 220 has a length from the starting end to the finishing end, which defines a travel distance for the respective follower portion. The lengths of the track portions 220 are substantially equal to each other. The first angle is about 120°, being 360° divided by a number of track portions 220 (three). In other examples, the engagement feature may include two track portions, four track portions, five track portions, or more than five track portions that are angularly spaced apart from each other.

The track portions 220 are longitudinally offset with respect to each other. There is a constant longitudinal spacing between sequential track portions 220.

Each track portion 220 has a pitch profile with a pitch that varies along a length of the track portion 200. In particular, the track portion has a first pitch in a first region and a second pitch, that is less than the first pitch, in a second region, the pitch profiles of the track portions being substantially similar. For each track portion 220, the second region is at a lower elevation than the first region. In other examples, for each track portion, the second region is at a higher elevation than the second region. The first pitch is about 10 times larger than the second pitch. In particular, the first pitch is about 27 μm/° and the second pitch is about 2.4 μm/°. Each track portion 220 has one or more intermediate pitches in respective one or more intermediate regions, the or each intermediate region being between the first and second regions. Each intermediate pitch is less than the first pitch and larger than the second pitch. The intermediate pitch(es) provide(s) a smooth transition between the first region and the second region.

In other examples, the first pitch may be at least about 2 times larger than the second pitch, at least about 5 times larger, or about 20 times larger than the second pitch. The first pitch may be at least about 5 μm/°, at least about 10 μm/°, at least about 15 μm/°, or at least about 20 μm/° for example. Preferably, the first pitch is between about 20 μm/° and 40 μm/°. Further preferably, the first pitch is between about 25 μm/° and 35 μm/°. The second pitch may be up to about 5 μm/°, up to about 10 μm/°, up to about 15 μm/°, or up to about 20 μm/° for example. Preferably, the second pitch is between about 1 μm/° and 5 μm/°. Further preferably, the second pitch is between about 2 μm/° and 3 μm/°.

Each track portion 220 spirals in the longitudinal direction by a dwell angle. The dwell angle is an angle about the rotation axis from one end of the track portion to an opposite end of the track portion. The first region (with the higher pitch) is in an upper half of the dwell angle and the second region (with the lower pitch) is in a lower half of the dwell angle. The dwell angle is about 40% larger than the first angle, that is about 170°. The upper 85 degrees is the steep part of the track portion (with the higher pitch) and the lower 85 degrees is the flatter part of the track portion (with the lower pitch). The pitch (or steepness) of the track portion begins very steep (2.2 mm/85 degrees of rotation) in the first region which correspond to the grinding burrs being far apart for coarse grinding, and flattens out (0.2 mm/85 degrees of rotation) in the second region which correspond to the grinding burrs getting closer together for finer grinding. The transition from the steep part to the flatter part begins at 80 degrees and ends at 90 degrees of rotation. In other examples the dwell angle may be at least 10%, at least 20%, at least 30%, at least 40% or at least 50%, or at least about 100% of the first angle.

The guide 200 includes a plurality of entry regions 260 that are axially spaced apart from each other about the rotational axis. Each entry region 260 is for a respective follower portion and leads from the flange 240 to a respective track portion 220. In particular, the entry region 260 has a width that corresponds to the width of the respective follower portion. The entry region 260 may be a recessed portion or a vertical channel that leads to the respective track portion 220. In this example, the burr portion is removably locatable with respect to the guide by aligning the follower portions with the entry regions of the respective track portions. The entry regions 260 have different widths that correspond to respective widths of the follower portions to ensure that the burr portion is correctly received by the guide 200. In this regard, the entry region 260 leading to the third track portion 220 is the largest in width compared to the other entry regions, while the entry region 260 leading to the first track portion is the smallest in width compared to the other entry regions.

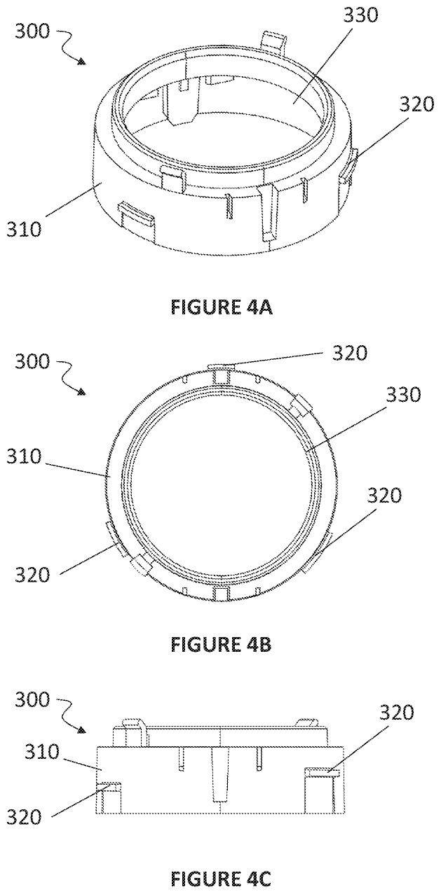

With reference to FIGS. 4A to 4C, the burr portion 300 has a ring-shape (or annular) body for complementarily receiving the first grinding burr (120 shown in FIGS. 1A to 1C) and for being complementary received by the guide (200 shown in FIGS. 3A to 3C). The burr portion 300 is a burr holder for removably receiving a first grinding burr. The first grinding burr when received by the burr holder is height-adjustable, in unison with the burr holder, relative to a rotatable second grinding burr, that is centrally located with respect to the first grinding burr, to adjust a grind size from grinding of coffee beans in the grinding space between the first grinding burr and the second grinding burr upon rotation of the second grinding burr with respect to the first grinding burr. In other examples, the burr portion is integral with the first grinding burr or the second grinding burr. The burr portion 300 is a collar having an inner circumferential wall 330 defining a space within which the first grinding burr is receivable.

The burr portion 300 has a plurality of follower portions 320 on its outer circumferential wall 310 that are angularly and longitudinally offset with respect to each other about the rotation axis. The follower portions 320 in particular are projections or tabs that protrude outwardly from the outer circumferential wall 300 of the burr portion 300. The various angular and longitudinal positions of the three follower portions allow for three unique starting points for the track portions of the guide, which allows for the variable pitch track portions to co-exist in a single part without interfering (crashing) with each other. Each follower portion 320 is engageable with a respective track portion of the guide as previously described. When engaged, the rotation of the guide with respect to the burr portion about the rotation axis causes each follower portion 320 to be guided along the respective track portion to which it is engaged to thereby longitudinally adjust the burr portion with respect to the guide.

The follower portions 320 include at three follower portions, each follower portion being engageable with a respective track portion (220 in FIGS. 3A to 3C). In particular, the three follower portions 320 include a first follower portion that is engageable with the first track portion, a second follower portion that is engageable with the second track portion, and a third follower portion that is engageable with the third track portion. The second follower portion is angularly offset from the first follower portion by about 120° and the third follower portion is angularly offset from the second follower portion also by about 120°. The three follower portions 320 are also longitudinally offset from each other. There is a constant longitudinal spacing between sequential follower portions 320. The spacing may be about between about 2.00 mm to 3.00 mm.

Each follower portion 320 has a width that is different from a width of the other follower portions 320. The width of each follower portion 320 corresponds to the width of the entry region leading to the respective tracks with which the follower portions 320 are engageable. By way of example, the first follower portion may have a width of about 5.75 mm that is receivable in an entry region, leading to the first track portion, of a width of about 7.10 mm; the second follower portion may have a width of about 8.20 mm that is receivable in an entry region, leading to the second track portion, of a width of about 9.50 mm; and the third follower portion may have a width of about 10.25 mm that is receivable in an entry region, leading to the third track portion, of a width of about 11.80 mm. The different widths of the follower portions combined with the complementary widths of the entry regions ensure that the burr portion 300 is correctly received by the guide such that all of the follower portions are engages with the respective track portions.

When the follower portions 320 are engaged with the track portions of the guide and the guide is rotated, the follower portions 320 would transition between the first and second regions of the respective track portions in unison upon rotation of the guide with respect to the burr portion. Because the track portions have a varying pitch profile as previously described, the linear longitudinal movement of the burr portion would be non-uniform in response to rotation of the guide. Rotating the track portions through the second region of the respective track portions would result in the grinding burrs moving vertically relative to each other by a fraction (e.g. 1/10) of the distance per degree of rotation compared to when the track portions are rotated through the first region of the respective track portions.

When the follower portions are in the first region of the respective track portions (with the first larger pitch of about 27 μm/°), the rotation would result in a larger longitudinal movement of the burr portion. The follower portions in this first region of the respective track portions provide for a coarse grind range (450 microns-1400 microns) for coffee beans.

When the follower portions are in the second region of the respective track portions (with the second smaller pitch of about 2.4 μm/°), the rotation would result in a smaller longitudinal movement of the burr portion. The follower portions in this second region of the respective track portions provide for a finer, espresso, coarse grinding range. The varying pitch profile of the track portions result in a greater resolution for fine tuning espresso grind.

The various embodiments of the present invention described above have been presented by way of example only, and not by way of limitation. It will be apparent to a person skilled in the relevant art that various changes in form and detail can be made therein without departing from the spirit and scope of the invention. The present invention should not be limited by any of the exemplary embodiments described above.

1. A burr-adjustment system for a coffee grinder, the burr-adjustment system including:
a burr portion for a first grinding burr; and
a guide for coupling to the coffee grinder, the guide being engageable with the burr portion via an engagement feature such that, when engaged, the guide is rotatable about a rotation axis with respect to the burr portion to longitudinally adjust the burr portion relative to the guide,
wherein the engagement feature includes:
track portions that are angularly and/or longitudinally offset with respect to each other about the rotation axis, each track portion spirals in a longitudinal direction about the rotation axis and has a pitch profile with a first pitch in a first region and a second pitch, that is less than the first pitch, in a second region, the pitch profiles of the track portions being substantially similar, and
follower portions that are angularly and/or longitudinally offset with respect to each other about the rotation axis, each follower portion being engageable with a respective track portion,
wherein the rotation of the guide with respect to the burr portion about the rotation axis causes each follower portion to be guided along the respective track portion to which it is engaged to thereby longitudinally adjust the burr portion with respect to the guide, wherein the follower portions transition between the first and second regions of the respective track portions in unison upon rotation of the guide with respect to the burr portion.

2. The burr-adjustment system of claim 1, wherein
the track portions are angularly offset with respect to each other about the rotation axis by a first angle that is 360° divided by a number of track portions; and
the follower portions are angularly offset with respect to each other about the rotation axis also by the first angle.

3. The burr-adjustments system of claim 1 or 2, wherein the track portions are longitudinally offset with respect to each other and the track portions are longitudinally offset with respect to each other.

4. The burr-adjustment system of any one of claims 1 to 3, wherein the track portions include three track portions and the follower portions include at three follower portions each follower portion being engageable with a respective track portion.

5. The burr-adjustment system of any one of claims 1 to 4, wherein the guide includes the track portions and the burr portion includes the follower portions.

6. The burr-adjustment system of any one of claims 1 to 5, wherein, for each track portion, the second region is at a lower elevation than the first region.

7. The burr-adjustment system of any one of claims 1 to 6, wherein the or each track portion spirals in the longitudinal direction by a dwell angle, the first region being in a first half of the dwell angle and the second region being in a second half of the dwell angle.

8. The burr-adjustment system of claim 7, wherein the first half is an upper lower half of the respective track portion and the second half is a lower half of the respective track portion.

9. The burr-adjustment system of claim 7 or 8, wherein the dwell angle is 170°.

10. The burr-adjustment system of any one of claims 1 to 9, wherein the first pitch is at least 10 times larger than the second pitch.

11. The burr-adjustment system of any one of claims 1 to 10, wherein the first pitch is 27 μm/°.

12. The burr-adjustment system of any one of claims 1 to 11, wherein the second pitch is 2.4 μm/°.

13. The burr-adjustment system of any one of claims 1 to 12, wherein each track portion is a groove and each follower portion is a protrusion that is locatable in the groove of the respective track portion.

14. The burr-adjustment system of any one of claims 1 to 13, wherein each follower portion has a width that is different from a width of the other follower portion(s) and the engagement feature has a plurality of entry regions, each entry region being for the respective follower portion and leading to the track portion.

15. The burr-adjustment system of any one of claims 1 to 14, wherein the burr portion is a burr holder for removably receiving a first grinding burr, the first grinding burr when received by the burr holder being height-adjustable, in unison with the burr holder, relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr.

16. The burr-adjustment system of any one of claims 1 to 14, wherein the burr portion is an integral part of a first grinding burr, the first grinding burr being height-adjustable relative to a rotatable second grinding burr, that is centrally located with respect to the first grinding burr, to adjust a grind size from grinding of coffee beans in a space between the first grinding burr and the second grinding burr upon rotation of the second grinding burr with respect to the first grinding burr.

17. A burr-adjustment system for a coffee grinder, the burr-adjustment system including:
a burr portion for a first grinding burr; and
a guide for coupling to the coffee grinder, the guide being engageable with the burr portion via an engagement feature such that, when engaged, the guide is rotatable about a rotation axis with respect to the burr portion to longitudinally adjust the burr portion relative to the guide,
wherein the engagement feature includes:
a track portion that spirals in a longitudinal direction about the rotation axis and has a pitch profile with a first pitch in a first region and a second pitch, that is less than the first pitch, in a second region, and
a follower portion that is engageable with a respective track portion.

18. A coffee grinder including:
a first grinding burr;
a second grinding burr that is centrally located with respect to the first grinding burr, the second grinding burr being rotatable relative to the first grinding burr to grind coffee beans contained in a space between the first grinding burr and the second grinding burr; and
the burr-adjustment system of any one of claims 1 to 17, wherein the burr portion of the burr-adjustment system is of the first grinding burr;
wherein rotation of the guide relative to the burr portion of the burr-adjustment system adjusts the height of the first grinding burr with respect to the second grinding burr to adjust a grind size from grinding of coffee beans in the space between the first grinding burr and the second grinding burr.

19. A coffee grinder comprising:
a first grinding burr;
a second grinding burr; and
an adjustment mechanism that is rotatable to adjust a height of the first grinding burr with respect to the second grinding burr to adjust a grind size from grinding of coffee beans in a space between the first grinding burr and the second grinding burr, the adjustment mechanism comprising a plurality of circumferentially spaced apart track portions, each track portion being engageable with a respective follower portion and having a varying pitch along its length, wherein a rotation of the adjustment mechanism results in a translational movement of the track portions relative to the respective follower portions to thereby adjust the height of the first grinding burr with respect to the second grinding burr;
wherein the first grinding burr has or is engageable with the adjustment mechanism.

20. The coffee grinder of claim 19, wherein:
the first grinding burr is engageable with the adjustment mechanism; and
the first grinding burr includes the follower portions that are engageable with the respective track portions.

21. The coffee grinder of claim 18 or 19, wherein the track portions are non-contiguous.

22. A coffee grinder comprising:
a first grinding burr;
a second grinding burr;
a burr holder having a plurality of follower portions, wherein the first grinding burr has or is engageable with the burr holder; and
an adjusting ring comprising a plurality of circumferentially spaced apart track portions, each track portion having a varying pitch,
wherein the adjusting ring is rotatable relative to the burr holder to adjust a height of the first grinding burr with respect to the second grinding burr to adjust a grind size from grinding of coffee beans in a space between the first grinding burr and the second grinding burr, and
wherein the varying pitch of each track portion provides a non-uniform height adjustment of the first grinding burr with respect to the second grinding burr upon rotation of the adjusting relative to the burr holder.

23. A beverage ingredient grinder comprising:
a first grinding element;
a second grinding element spaced apart from the first grinding element to define a grinding chamber for a beverage ingredient; and
an adjustment mechanism comprising:
an adjusting ring comprising a plurality of circumferentially spaced apart track portions, each track portion comprises or includes a varying pitch, wherein a rotation of the adjustment ring adjusts the distance between the first and second grinding elements.

24. A beverage ingredient grinder comprising:
a first grinding element;
a second grinding element, the second grinding element spaced apart from the first grinding element to define a grinding chamber for the beverage ingredient; and
an adjustment mechanism comprising:
an adjusting ring comprising a plurality of non-contiguous track portions, wherein each track portion comprises or includes a varying pitch, wherein a rotation of the adjustment ring adjusts the distance between the first and second grinding elements.

25. A beverage ingredient grinder comprising:
a first grinding element;
a second grinding element spaced apart from the first grinding element to define a grinding chamber for a beverage ingredient; and
an adjustment mechanism comprising:
an adjusting ring comprising at least one track portion, wherein the at least one track portion comprises or includes a varying pitch; and
wherein a rotation of the adjustment ring adjusts the distance between the first and second grinding elements.
